(19) United States
(12) Patent Application Publication
(10) Pub. No.: US 2021/0113003 A1
(43) Pub. Date: Apr. 22, 2021

(54) DRINKING STRAW DOCK AND METHOD OF MANUFACTURING SAME

(71) Applicants: Daniel O'Cone, Point Pleasant Beach, NJ (US); Matthew Rega, Point Pleasant, NJ (US)

(72) Inventors: Daniel O'Cone, Point Pleasant Beach, NJ (US); Matthew Rega, Point Pleasant, NJ (US)

(21) Appl. No.: 17/075,695

(22) Filed: Oct. 21, 2020

Related U.S. Application Data
(60) Provisional application No. 62/924,239, filed on Oct. 22, 2019.

(51) Int. Cl. A47G 19/30; B23B 35/00

(52) U.S. Cl. CPC A47G 21/184; B23B 35/00

(57) ABSTRACT

A drinking straw holder includes a rigid holder having a top surface, a bottom surface, a front surface, a back surface, and two side surfaces, the rigid holder being angled relative to a resting plane, the rigid holder defining a plurality of circular apertures arranged in columns and rows and extending from the top surface to the bottom surface, the rigid holder further defining a lateral bore extending through the rigid holder from one side surface to an opposing side surface, the lateral bore forming a window.

### CROSS-REFERENCE TO RELATED APPLICATIONS

The present application claims priority to Provisional Patent Application Ser. No. 62/924,239, filed Oct. 22, 2019, entitled “DRINKING STRAW DOCK AND METHOD OF MANUFACTURING SAME,” the disclosure of which is hereby incorporated by reference in its entirety as if fully set forth herein.

### FIELD OF THE DISCLOSURE

The present disclosure relates to devices and methods for storing drinking straws. More specifically, the present disclosure relates to devices and methods for storing reusable drinking straws.

### BACKGROUND OF THE DISCLOSURE

There is growing concern over how the prevalence of plastic products affects the environment. One example is the use of plastic drinking straws. Plastic straws do not easily decompose or biodegrade, and typically end up in landfills, or in the oceans, poisoning fish and other wildlife. In fact, according to some studies, humans have created about 9.1 billion tons of plastic, and most of it is not recycled.

One solution has been to replace plastic drinking straws with paper straws that are biodegradable. Many do not like to use paper straws due to their texture, and their tendency to become soggy especially in hot or warm drinks. Alternatively, rigid reusable straws are now being manufactured and sold. The rigid reusable straws are typically made of a metal (e.g., stainless steel) or other similar rigid materials. Though reusable straws reduce the consumption of drinking straws, they are typically placed in drawers or on shelves, and are often misplaced or lost. Additionally, these drinking straws may become dirty and may need to be cleaned prior to use. This makes them less likely to be used.

### SUMMARY OF THE DISCLOSURE

In some embodiments, a drinking straw holder includes a supporting base, and a rigid holder coupled to the supporting base and having a top surface and a bottom surface, the rigid holder being angled relative to a resting surface, the rigid holder defining a plurality of circular apertures arranged in columns and rows and extending from the top surface to the bottom surface, the rigid holder further defining a lateral bore extending through the rigid holder from one side to an opposing side, the lateral bore forming a window.

### BRIEF DESCRIPTION OF THE DISCLOSURE

Various embodiments of the presently disclosed drinking straw docks are disclosed herein with reference to the drawings, wherein:

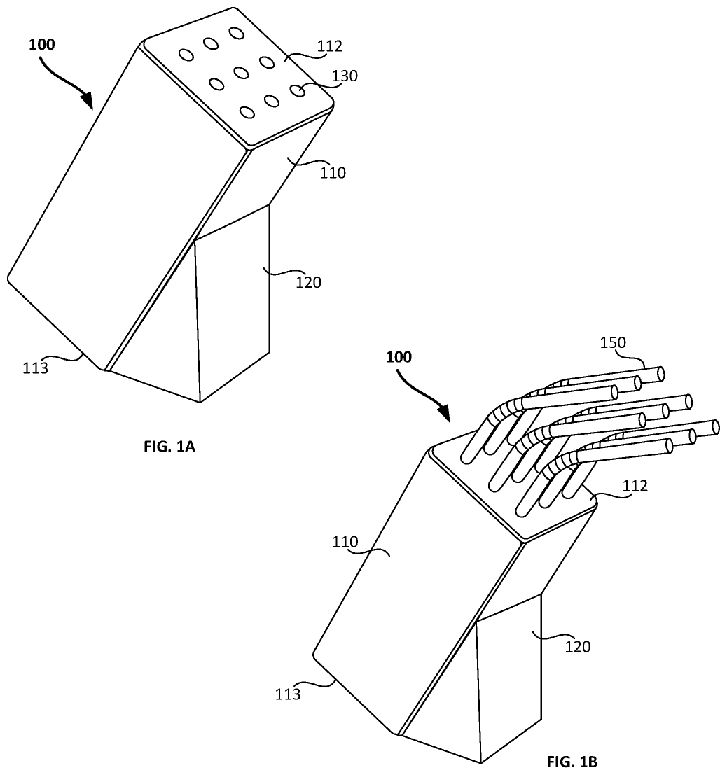

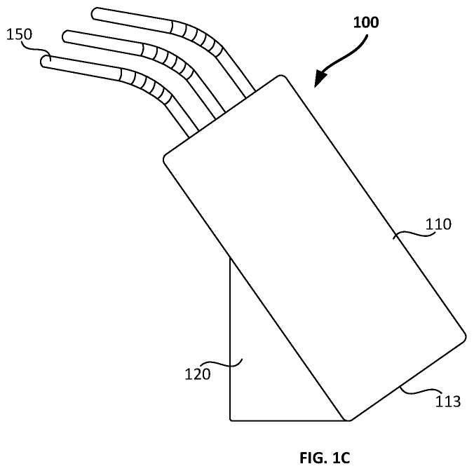

FIGS. 1A-C are schematic perspective and side views of a straw dock according to one example of the disclosure;

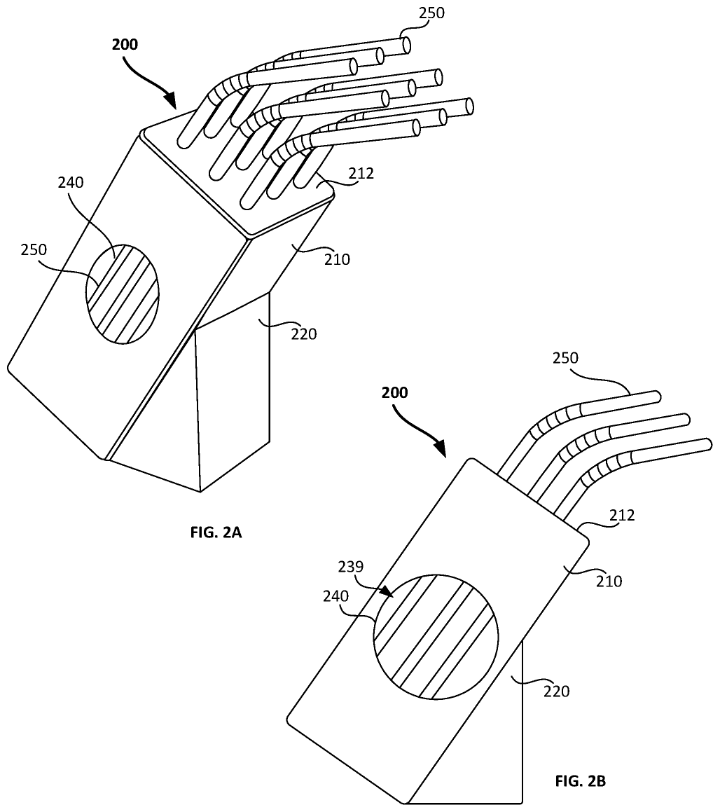

FIGS. 2A-B are schematic perspective and side views of a straw dock according to another example of the disclosure;

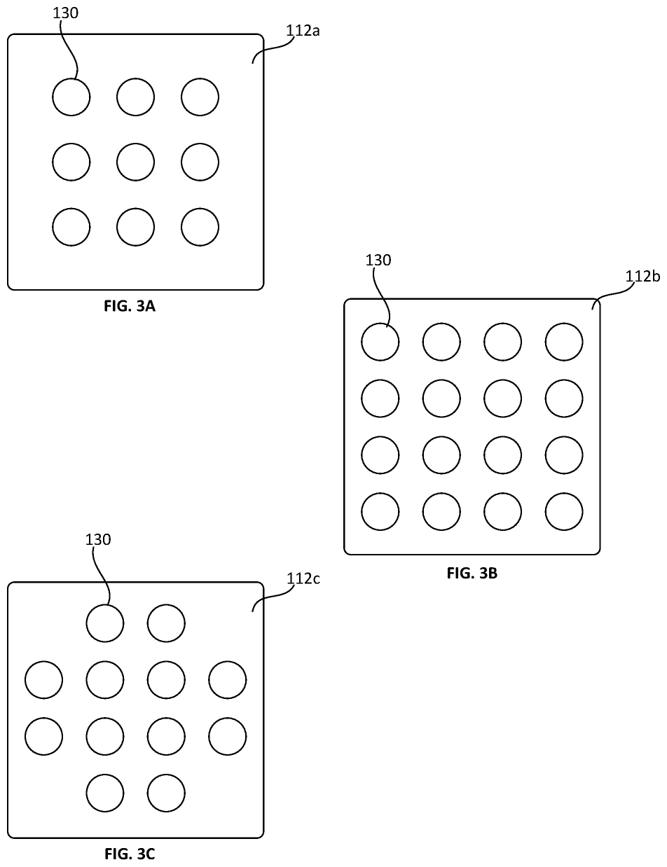

FIGS. 3A-C are schematic top views of a straw dock according to various examples of the disclosure; and

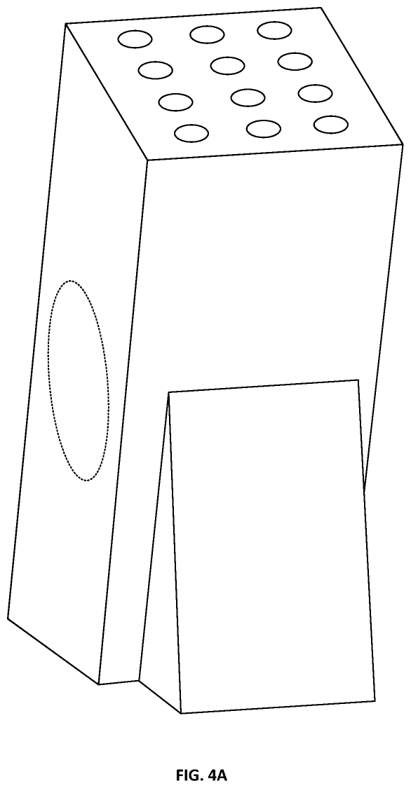

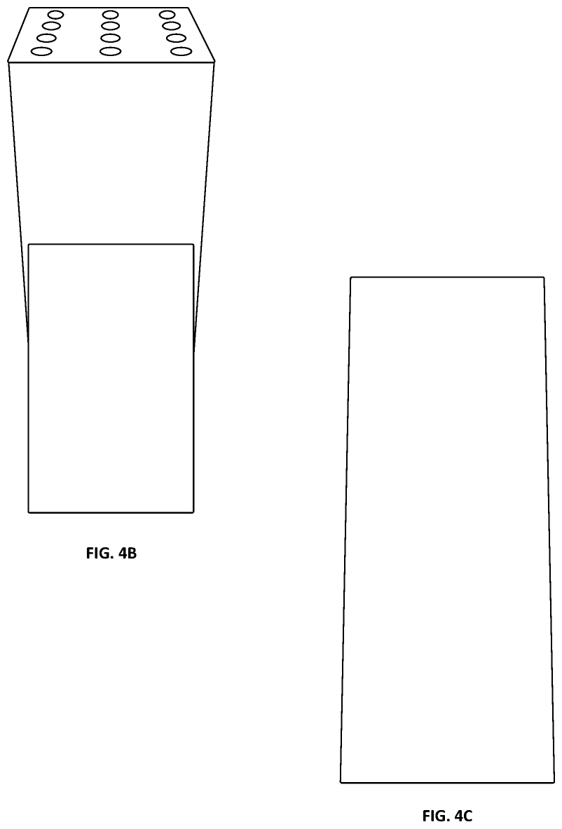

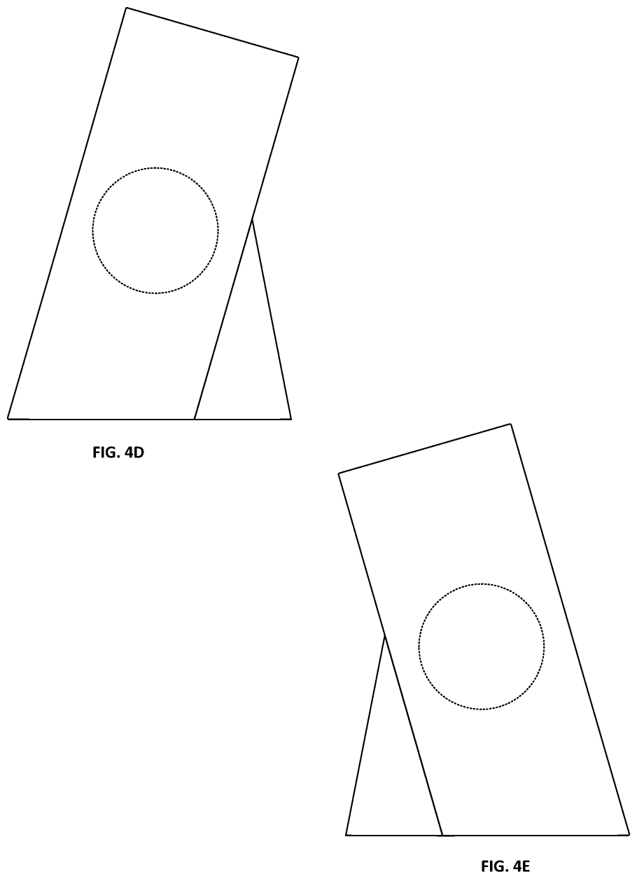

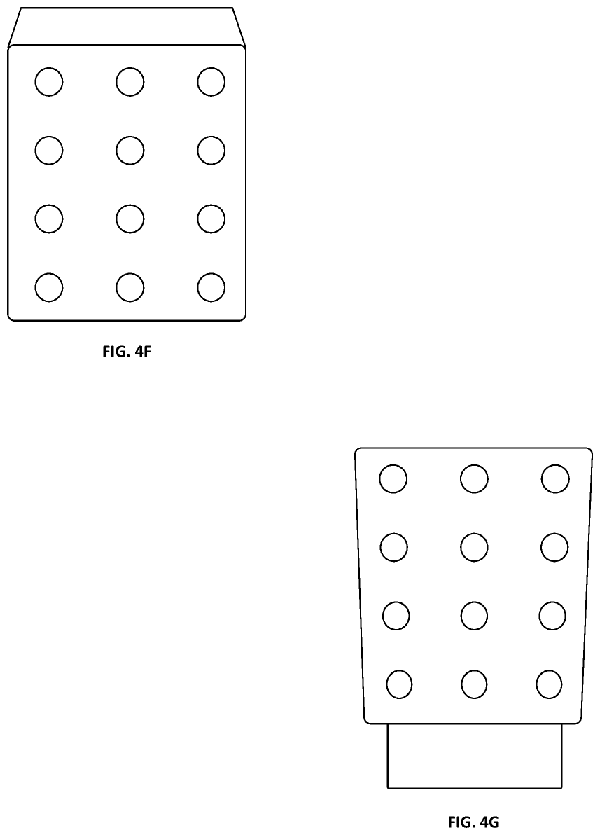

FIGS. 4A-G are schematic views of a straw dock according to another example of the disclosure.

Various embodiments of the present invention will now be described with reference to the appended drawings. It is to be appreciated that these drawings depict only some embodiments of the disclosure and are therefore not to be considered limiting of its scope.

### DETAILED DESCRIPTION

Despite the various improvements that have been made to drinking straws, conventional devices and methods suffer from certain shortcomings such as those discussed above.

There therefore is a need for further improvements to the devices and methods used to store drinking straws. Among other advantages, the present disclosure may address one or more of these needs.

In a first embodiment, shown in FIGS. 1A-C, a straw dock 100 may generally include a holder 110 coupled to a supporting base 120. In this example, holder 110 is in the shape of a block of material and supporting base 120 is a wedge-shaped or triangular member used to provide a wider base to keep the holder 110 upright and angled toward the user. In some examples, holder 110 and supporting base 120 made be formed of wood. Alternatively, holder 110 and supporting base 120 may be formed of a metal or other suitable rigid material. The two components may be unitarily formed, or coupled together via screws, nails, adhesive, or other suitable fastener(s). Holder 110 may be angled off the resting surface (e.g., a tabletop or countertop), and the angle of the holder may be chosen (e.g., 15, 20 or 30 degrees off the vertical axis) to allow the user to easily grasp and see the straws in it. A number of apertures 130 may be drilled or otherwise formed in the holder 110 along its length. Apertures 130 may be cylindrical with a circular opening and slightly larger than the diameter of the drinking straws. In at least some examples, apertures 130 may be between ⅛ and ½ of an inch. In at least some examples, the apertures are drilled into the holder from one end (e.g., from the top surface or face 112 and through it) to the other (e.g., to the bottom surface 113 and through it). By extending the apertures through the holder, it is possible to form a drainage channel so that water from wet straws can exit out the bottom of the holder. As shown, the apertures are disposed in rows and columns of three to accept a total of nine drinking straws 150 (FIG. 1B) although other configurations are possible (See, FIGS. 4A-G).

In another example shown in FIGS. 2A-B, straw dock 200 includes a holder 210 and a base 220 similar to dock 100. The main difference between dock 200 and dock 100 is the inclusion of a lateral bore 239 extending from one side surface of the holder to, and through, an opposite side surface, the bore forming a window 240 through which portions of the straws 250 are visible. The lateral bore may reduce the weight of the straw dock without reducing its integrity. Additionally, the lateral bore 239 may reduce the weight of the holder 210 so that the size of the supporting base 120 may be reduced while still providing sufficient bracing of the holder at an angle. With wooden straw docks, bore 239 also will reveal the grain of the wood which increases the aesthetic appeal of the product.

As previously mentioned, the number of apertures may be varied so that the holder is capable of accepting a varying number of drinking straws. FIGS. 3A-C show schematics of faces 112a-c of different holders having varying configurations. In FIG. 3A, apertures 130 are arranged in three rows and three columns. Each row and each column includes three apertures, and a total of nine apertures are formed so that the holder may accept nine drinking straws. The apertures 130 may be spaced evenly on the face 112a as shown. It will be understood that rows may include a different number of apertures from one another, and/or columns may include a different number and/or size of apertures from one another. Additionally, as shown in FIG. 3B, the number of apertures 130 may be varied so that more or fewer drinking straws are accepted in the face. In the embodiment of FIG. 3B, four rows and four columns of apertures are formed, and each row and each column includes four apertures for a total of 16 apertures in face 112b. Other variations are possible such as that shown in FIG. 3C, where face 112c includes a cross-shaped configuration of four rows of apertures. Face 112a includes a first row of two apertures, second and third rows of four apertures each, and a fourth row of two apertures. The apertures may cover all or substantially all of the face 112 of the holder. Additionally, the apertures may all be circular and of the same size as shown.

As shown in FIGS. 4A-G, a holder may be used to accommodate twelve drinking straws, and may include three columns and four rows of circular apertures. The circular apertures may be all of a same size and shape. Additionally, a lateral bore may be included, the lateral bore being sized and shaped to expose middle portions of the drinking straws (e.g., portions between the inlet and the outlet of the drinking straws).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A drinking straw holder comprising:
a rigid holder having a top surface, a bottom surface, a front surface, a back surface, and two side surfaces, the rigid holder being angled relative to a resting plane, the rigid holder defining a plurality of circular apertures arranged in columns and rows and extending from the top surface to the bottom surface, the rigid holder further defining a lateral bore extending through the rigid holder from one side surface to an opposing side surface, the lateral bore forming a window.

2. The drinking straw holder of claim 1, further comprising a wedge-shaped supporting base coupled to the rigid holder.

3. The drinking straw holder of claim 2, wherein the wedge-shaped supporting base is coupled to the front surface of the rigid holder.

4. The drinking straw holder of claim 1, wherein the top surface is angled approximately 15 degrees with respect to the resting plane.

5. The drinking straw holder of claim 1, wherein the top surface is angled approximately 20 degrees with respect to the resting plane.

6. The drinking straw holder of claim 1, wherein the columns and rows include multiple rows and multiple columns.

7. The drinking straw holder of claim 6, wherein the columns are oriented from the back surface to the front surface and the rows are oriented between the two side surfaces.

8. The drinking straw holder of claim 7, wherein the columns include four columns.

9. The drinking straw holder of claim 7, wherein the rows include three rows.

10. The drinking straw holder of claim 7, wherein each of the plurality of circular apertures is sized to receive a drinking straw, and the lateral bore is sized, configured and arranged to expose at least a portion of at least three of the drinking straws.

11. A system comprising:
a plurality of drinking straws; and
a rigid holder having a top surface, a bottom surface, a front surface, a back surface, and two side surfaces, the rigid holder being angled relative to a resting plane, the rigid holder defining a plurality of circular apertures, each of the plurality of circular apertures being sizes to accept one of the plurality of drinking straws, the plurality of circular apertures being arranged in columns and rows and extending from the top surface to the bottom surface, the rigid holder further defining a lateral bore extending through the rigid holder from one side surface to an opposing side surface, the lateral bore forming a window that exposes ones of the plurality of drinking straws through the side surfaces.

12. The system of claim 11, wherein the window exposes at least two drinking straws.

13. A method of making a drinking straw holder comprising:
providing a rigid holder having a top surface, a bottom surface, a front surface, a back surface, and two side surfaces, the rigid holder being angled relative to a resting plane;
forming a plurality of circular apertures in the rigid holder, the plurality of circular apertures being arranged in columns and rows and extending from the top surface to the bottom surface; and
forming a lateral bore extending through the rigid holder from one surface to an opposing surface, the lateral bore forming a window.

14. The method of claim 13, wherein forming a plurality of circular apertures in the rigid holder comprises drilling into the rigid holder.

15. The method of claim 13, wherein forming a lateral bore in the rigid holder comprises drilling through the rigid holder.

16. The method of claim 13, wherein forming a lateral bore in the rigid holder comprises forming a lateral bore that extends from one side surface to an opposing side surface.
